(19) United States
(12) Patent Application Publication
(10) Pub. No.: US 2012/0031226 A1
(43) Pub. Date: Feb. 9, 2012

(54) CENTRIFUGAL FORCE PENDULUM

(75) Inventor: Stefan Jung, Kehl (DE)

(73) Assignee: SCHAEFFLER TECHNOLOGIES GMBH & CO. KG, Herzogenaurach (DE)

(21) Appl. No.: 13/272,397

(22) Filed: Oct. 13, 2011

Related U.S. Application Data
(63) Continuation of application No. PCT/DE2010/000297, filed on Mar. 18, 2010.

(30) Foreign Application Priority Data
Apr. 14, 2009 (DE) 102009017389.7

(51) Int. Cl. F16F 15/123

(52) U.S. Cl. 74/574.4

(57) ABSTRACT

A centrifugal force pendulum arranged on a rotatable pendulum flange, for example, in the drive train of a motor vehicle. Pendulum masses, which can be moved to a limited extent in the radial direction and circumferential direction during the deflection thereof, are provided at the sides of the pendulum flange, for example, mutually opposing each other. Said opposing pendulum masses are fastened to each other by a connecting element, forming a pendulum mass pair. A bearing is disposed on the connecting element.

### CROSS-REFERENCE TO RELATED APPLICATIONS

This application is filed under 35 U.S.C. §120 and §365(c) as a continuation of International Patent Application No. PCT/DE2010/000297 filed Mar. 18, 2010, which application claims priority from German Patent Application No. DE 10 2009 017 389.7 filed Apr. 14, 2009, which applications are incorporated herein by reference in their entireties.

### FIELD OF THE INVENTION

The invention relates to a centrifugal force pendulum.

### BACKGROUND OF THE INVENTION

Centrifugal force pendulums of this kind are known, for example, from the published German Patent Application No. DE 10 2006 028 556 A1. This document describes a pendulum flange that is rotatable about an axis of rotation and may be part of a torsional vibration damper. The pendulum flange is provided with recesses on whose tracks rolling bodies roll. The rolling bodies roll in recesses of pendulum masses that are preferably arranged on both sides of the side surfaces of the pendulum flange, with two respective opposing pendulum flanges being connected to each other by connecting elements. The shape of the recesses in the pendulum flange and in the pendulum masses predetermines the deflection and the swinging angles of the pendulum masses relative to the pendulum flange. When torsional vibrations occur, the pendulum masses are deflected relative to the pendulum flange and act as a torsional vibration absorber due to their oscillating movement along a pendulum track.

### BRIEF SUMMARY OF THE INVENTION

It is an object of the invention to provide a centrifugal force pendulum with improved ways of fixing the pendulum masses.

In accordance with the invention, a centrifugal force pendulum is arranged on a rotatable pendulum flange, for example, in the drive train of a motor vehicle. Pendulum masses, which can be moved to a limited extent in the radial direction and circumferential direction during the deflection thereof, are provided at the sides of the pendulum flange, for example, mutually opposing each other. Said opposing pendulum masses are fastened to each other by a connecting element, thus forming a pendulum mass pair. A bearing, which may advantageously be a rolling bearing or a journal bearing, is arranged on the connecting element. The bearing may also be a needle bearing, a roller bearing, or a ball bearing. This arrangement of the bearing on the connecting element is an improved way of attaching the pendulum masses to the pendulum flange. For instance, the number of required parts is reduced.

In accordance with one embodiment, the bearing rolls in the recess of the pendulum flange. An advantage of this attachment compared to the conventional way of fixing the pendulum masses is that lubrication between the rolling body and the track of the pendulum flange may be dispensed with. The centrifugal force in the rotating reference system of the pendulum flange causes a radially outward directed force to act on the bearing. Under these conditions, due to the mass inertia of the bearing, a torsional vibration of the pendulum flange causes a rolling movement in the recess of the pendulum flange. Due to the centrifugal force, this rolling movement occurs in the radially outward area of the recess on the rolling tracks.

Advantageously the connecting element to which the bearing and the pendulum masses are attached passes through the recess in the pendulum flange. Thus the pendulum masses are, for example, fixed to both sides of the connecting element and thus to both sides of the pendulum flange, for example, in complementary pairs.

In accordance with one embodiment, the shape of the recess in the pendulum flange defines the pendulum track of the pendulum mass, thus determining the movement of the pendulum mass with respect to the pendulum flange. For instance, due to the rolling movement of the bearing in the recess of the pendulum flange, the pendulum mass carries out a relative movement with respect to the pendulum flange. Consequently the recesses in the pendulum flange that are usually provided for the rolling movement of the rolling bodies can be dispensed with, thus increasing the mass of the pendulum mass and improving the absorbing effect of the centrifugal pendulum although the overall size remains the same. In addition, the pendulum mass does not require hardening, which would otherwise be necessary to increase its resistance to wear. Thus the manufacturing process is simplified. In particular, the shape of the recess can be used to influence the shape of the rolling movement of the bearing or of the pendulum mass relative to the pendulum flange. Moreover, the recess presents a limit to the rolling movement in the radial and circumferential directions. Thus the maximum angle of rotation of the pendulum mass relative to the pendulum flange can be predetermined

As viewed from a cross-sectional viewpoint of the pendulum flange, the shape of the recess is, for example, circular or semi-circular, the round region of the semicircle being advantageously arranged further outward than the straight region of the semicircle as viewed in the radial direction. The recess may also be kidney-shaped. An advantage of this shape is that at a transition from the rotating to the non-rotating pendulum flange, the bearing has a shorter fall in the recess as viewed in the radial direction. Thus the clunking sounds that may be created are reduced.

In accordance with one embodiment, the connecting element to which the bearing is attached is fixed to the pendulum mass by a rivet and/or screw connection or by an equivalent mechanical connection for fixing the connecting element to the pendulum mass. The connecting element itself may additionally act as a spacer pin and/or step-mounting pin of the pendulum masses arranged on both sides of the pendulum flange, thus potentially dispensing with separate spacer pins or step-mounting pins and further reducing the number of required parts.

In accordance with one embodiment of the invention, the centrifugal pendulum is included in a torsional vibration damper. The pendulum flange may be embodied as a functional part of the torsional vibration damper, for example as a damper flange or cover.

BRIEF DESCRIPTION OF THE SEVERAL VIEWS OF THE DRAWING

Further advantages and advantageous embodiments of the invention will become apparent from the figures listed below and their descriptions. For reasons of clarity, the figures are not drawn to scale.

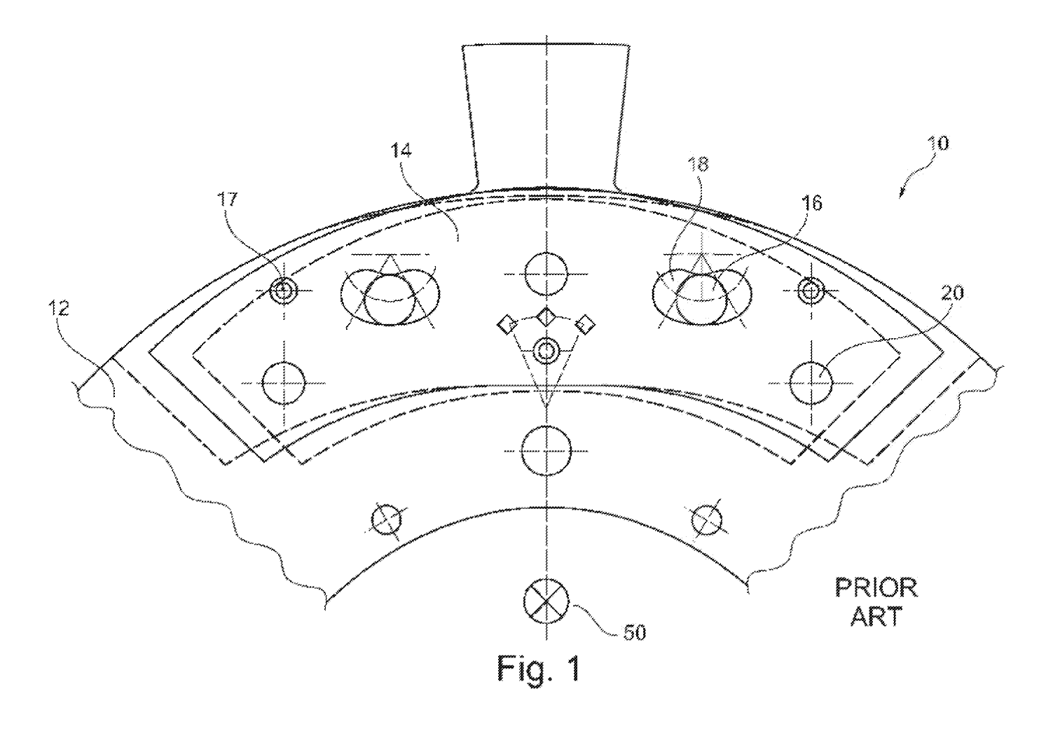

FIG. 1 is an elevational view of the recess of a centrifugal pendulum of the prior art;

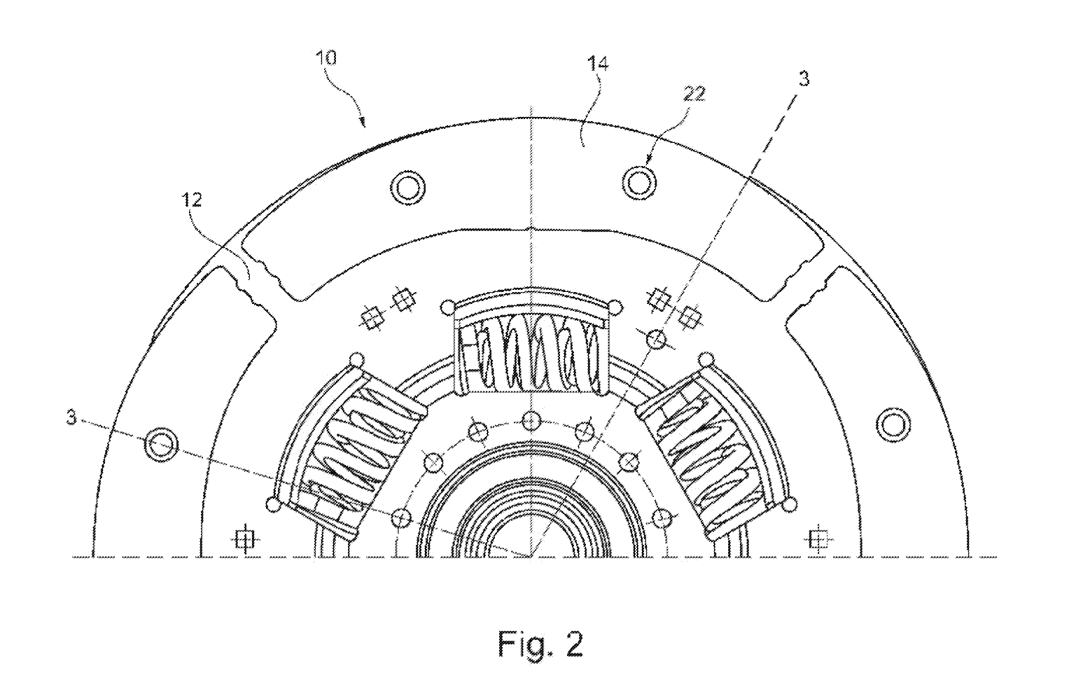

FIG. 2 is an elevational view of one half of a centrifugal pendulum;

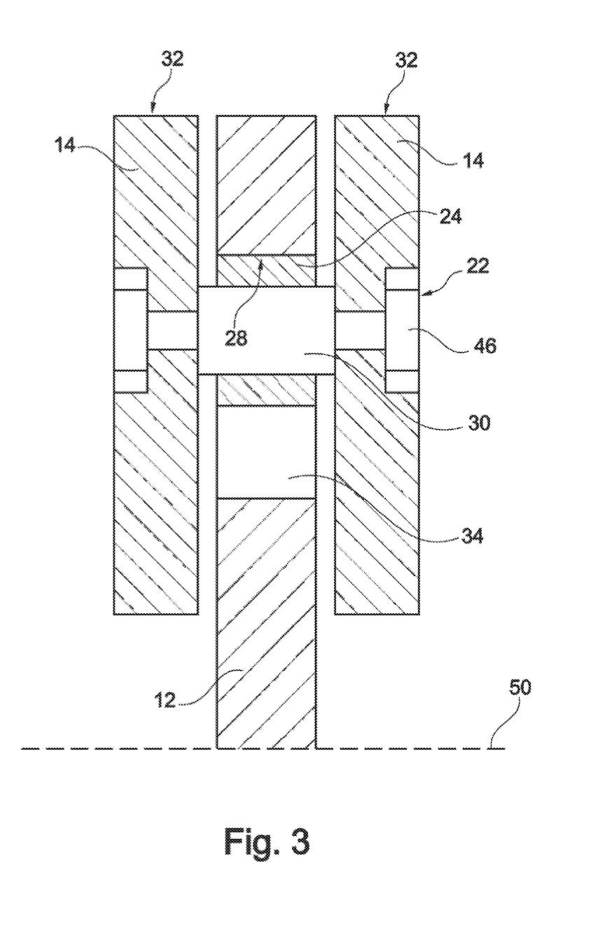

FIG. 3 is a cross-sectional view of the centrifugal pendulum of FIG. 2 taken along the line 3-3 of FIG. 2;

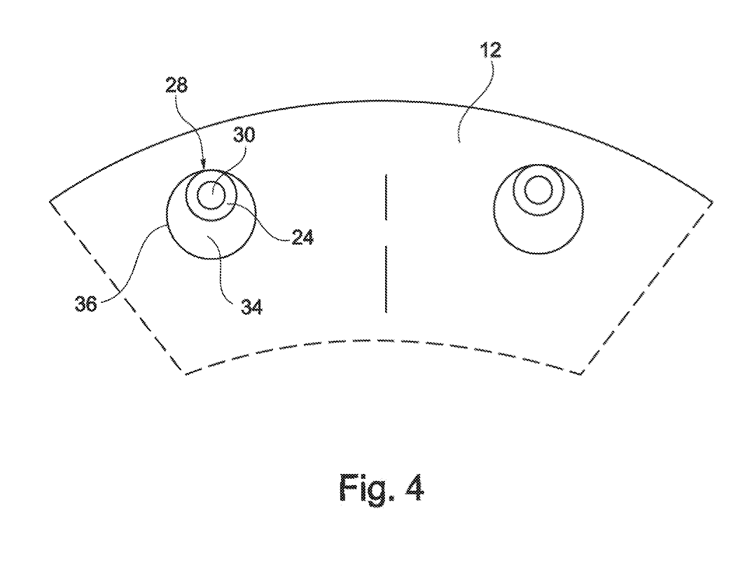

FIG. 4 is an elevational view of a pendulum flange with circular recesses; and

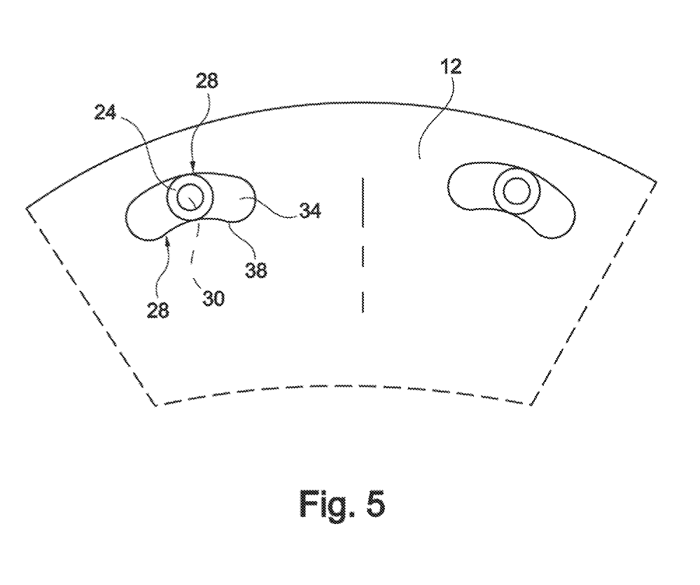

FIG. 5 is an elevational view of a pendulum flange with kidney-shaped recesses.

### DETAILED DESCRIPTION OF THE INVENTION

FIG. 1 is an elevational view of a centrifugal pendulum 12 as it is known from the prior art. The centrifugal pendulum comprises a pendulum flange 12. Pendulum masses 14 are fixed to the pendulum flange 12. The pendulum masses 14 are movable to a limited extent and are preferably arranged in pairs of mutually opposing masses in the axial direction 50. Movement of the pendulum masses is made possible by rolling bodies 16 that are guided in recesses 18 formed in the associated pendulum mass. Three spacer pins 20 are provided to fix the pendulum masses to the pendulum flange. In addition, axial contact elements 17, preferably made of plastic, are arranged on the pendulum masses 14 to reduce the noise that occurs when the pendulum masses 14 contacts the pendulum flange 12 in the axial direction perpendicular to the plane of the drawing.

FIG. 2 is an elevational view of the centrifugal pendulum 10. Connecting elements 22 are provided to fix the pendulum masses 14 to both sides of the pendulum flange 12. Preferably two connecting elements 22 are provided for each pendulum mass 14. The number of pendulum masses 14 may vary.

Due to this improved way of fixing the pendulum masses 14 to the pendulum flange 12, the recesses 18 in the pendulum masses 14 and separate rolling bodies 16 may be dispensed with. Consequently, the pendulum mass 14 does not need to be hardened because it includes neither recesses 18 nor tracks for the rolling bodies 16. Moreover, the volume of the pendulum mass 14 increases due to the elimination of the recesses 16 while the entire size of the device remains the same. This feature advantageously enhances the absorbing function of the centrifugal pendulum 10.

FIG. 3 is a cross-sectional view of the centrifugal pendulum 10 along the line 3-3 shown in FIG. 2. The pendulum mass 14 is attached to the pendulum flange 12 by means of a connecting element 22. A bearing 24, in particular a rolling bearing or a journal bearing, is arranged on the connecting element 22. The bearing may advantageously be located in a recess 34 of the pendulum flange 12. In the rotating reference system of the pendulum flange 12 the centrifugal force creates a force acting in a radially outward direction on the pendulum mass 14, the connecting element 22, and thus on the bearing 24. Under these conditions, a torsional vibration of the pendulum flange 12 may cause a rolling movement of the bearing 24 in the recess 34 of the pendulum flange 12 due to the mass inertia of the pendulum mass 14. Due to the centrifugal force, this rolling movement takes place in the radially outer region of the recess 34 on the tracks 28.

An advantage of this arrangement compared to the conventional way of fixing the pendulum masses 14 to the pendulum flange 12 is that no lubrication is necessary between the rolling body 16 and the track 28 of the pendulum flange 12. The recess 34 and tracks 28 of the recess represent a limit to the rolling movement of the bearing 24 in the radial and circumferential directions. Advantageously, the connecting element 22, to which the bearing 24 and the pendulum masses 14 are fixed, passes through the recess 34 in the pendulum flange 12. The pendulum masses 14 are preferably arranged on both sides of the connecting element 22 and thus on both sides of the pendulum flange 12 in the axial direction, for example, arranged as a pendulum mass pair 32 formed by opposing pendulum masses. The connecting element 22 may, for example, be attached to the pendulum mass 14 by a rivet or screw connection 46 or a comparable method of attachment. The connecting element 22 is advantageously embodied as a spacer pin and/or step-mounting pin 30 to ensure secure fasting of the pendulum mass 14 to the connecting element.

FIGS. 4 and 5 represent a section of the pendulum flange 12 with two recesses 34 shown by way of example. The shape of the recess 36, for example, defines the rolling movement of the bearing 24 fixed to the connecting element and in particular to the spacer pin 30, thus defining the pendulum path of the connected pendulum mass (not illustrated in FIG. 3) during the torsional vibration of the pendulum flange 12. In one example, the cross-sectional shape of the recess 34 is circular 36 as shown in FIG. 4, thus causing the pendulum mass 14 to pass through a circular path on the track 28 relative to the pendulum flange 12 during the rolling movement of the bearing 24.

FIG. 5 illustrates a further example in which the cross-section of the recess 34 is kidney-shaped 38. Thus, the radial distance between the bearing 24 and the radially inner limiting surface 40 of the recess 34 is reduced, minimizing the radial drop of the bearing 24. The result is a reduction of the noise that occurs when the centrifugal forces change spontaneously, for instance at a transition from the rotating to the non-rotating pendulum flange 12 and vice versa.

### LIST OF REFERENCE NUMERALS

10 centrifugal pendulum

12 pendulum flange

14 pendulum mass

16 rolling body

17 contact element

18 recess in the pendulum mass

20 spacer pin

22 connecting element

24 bearing

28 track

30 spacer pin

32 pair of pendulum masses

34 recess

36 circular recess

38 kidney-shaped recess

40 radially inner limiting surface

50 axial direction

What I claim is:

1. A centrifugal pendulum (10) comprising:
a rotatable pendulum flange (12);
pendulum masses (14) that are arranged on both sides of the pendulum flange (12) in the axial direction (50) and are movable to a limited extent relative to the pendulum flange, the opposing pendulum masses being connected to each other by means of at least one connecting element (22); and
at least one bearing arranged on the at least one connecting element (22).

2. The centrifugal pendulum (10) as set forth in claim 1, wherein the bearing (24) is arranged in a recess (34) of the pendulum flange.

3. The centrifugal pendulum (10) as set forth in claim 2, wherein the connecting element (22) passes through the recess (34) in the pendulum flange (12).

4. The centrifugal pendulum (10) as set forth in claim 2, wherein the shape of the recess (34) in the pendulum flange alone defines the pendulum path.

5. The centrifugal pendulum (10) as set forth in claim 2, wherein the shape of the recess (34) is circular (36), semi-circular, or kidney-shaped (38).

6. The centrifugal pendulum (10) as set forth in claim 1, wherein the connecting element (22) is riveted and/or screwed to the pendulum mass (14).

7. The centrifugal pendulum (10) as set forth in claim 1, wherein a plurality of connecting elements (22) of stepped construction are provided.

8. The centrifugal pendulum (10) as set forth in claim 7, wherein the connecting elements (22) are designed as spacer pins (30).

9. The centrifugal pendulum (10) as set forth in claim 1, wherein the at least one bearing is designed as at least one rolling bearing and/or a journal bearing.

10. A torsional vibration damper comprising a centrifugal pendulum as set forth in claim 1.
